(19) United States
(12) Patent Application Publication
(10) Pub. No.: US 2019/0061687 A1
(43) Pub. Date: Feb. 28, 2019

(54) AUTO SECURITY AND AUTO SAFETY SYSTEM

(71) Applicant: Akhtar Khalil, London (GB)

(72) Inventor: Akhtar Khalil, London (GB)

(21) Appl. No.: 15/520,376

(22) PCT Filed: Oct. 16, 2015
(86) PCT No.: PCT/GB15/53092

§ 371 Date: Apr. 19, 2017

(30) Foreign Application Priority Data
Oct. 19, 2014 (GB) 1418528.4
Apr. 5, 2015 (GB) 1505841.5

(51) Int. Cl. B60R 25/24; H04W 12/06; B60R 25/23; B60R 25/04; B60R 25/22; B60R 25/10; B60R 25/20

(52) U.S. Cl. CPC B60R 25/241; H04W 12/06; B60R 25/23; B60R 25/04; B60K 28/063; B60R 25/10; B60R 25/2072; B60R 2325/205; B60R 25/22

(57) ABSTRACT

A method for implementing security on a vehicle, comprising integrating an auto device on the vehicle; receiving, at the auto device, input from a remote device to authenticate the remote device to the auto device; verifying, at the auto device, that the remote device is a first authenticated remote device or one of a sequence of at least one subsequently authenticated remote devices; and enabling a security related function of the vehicle upon receiving, at the auto device, instruction from the remote device if the remote device is a first authenticated remote device.

### RELATED APPLICATIONS

The instant application is the national stage application of the International Application Number PCT/GB2015/053092, filed on Oct. 16, 2015, which claims the benefit and priority to the Great Britain Application Number 1418528.4 filed on Oct. 19, 2014 and further to the Great Britain Application Number 1505841.5 filed on Apr. 5, 2015, all of which are incorporated herein by reference in their entirety.

### FIELD

The present disclosure relates to an auto security and safety system, and more particularly to a wireless anti-theft and anti-snatching apparatus that receives user input through a remote device such as a smart phone to activate or deactivate security on an automobile/vehicle.

### DESCRIPTION OF THE RELATED ART

Millions of cars are subjected to auto theft each year with more than 1.5 million in Europe and more than a million automobiles in United States each year. This issue is more pressing in the developing and under-developed countries. As mentioned in U.S. Pat. No. 8,672,079, there is a common misconception that smaller sedans are the main targets of car thieves. However, from motorbikes to smaller cars to luxury vehicles, larger jeeps and trucks, car thieves prey on any type of vehicle that is insufficiently protected from theft. Stolen trucks account for 3 of the top 10 most stolen vehicles in the U.S. each year.

Security apparatus for preventing the theft of cars and other automobiles are well-known in the art. A number of different apparatus have been developed to prevent auto theft. Unfortunately, professional car thieves can easily bypass traditional car alarm systems and other existing security systems. Well-trained professionals know the ins and outs of existing car anti-theft devices and can frequently circumvent these devices. Car snatching is another problem especially in the developing and under developed countries where if the driver shows any resistance then thieves would most likely harm the driver. It is very common in many countries that thieves would access an owners car at gun point. That is snatching or forcing them to give away keys or other remote control devices/immobilizers/keyless entry systems. Thieves have managed even to cut fingers off drivers for bypassing biometric based security systems. This results in catastrophe for such vehicle owners. There is also a big concern of driving a vehicle by a drunk driver. Some of the existing auto security systems are listed below.

Vehicle tracking systems are used for tracking an automobile. The most commonly used technology for modern vehicle tracking systems are GPS or GLONASS technology. However, other types of automatic vehicle location technology can also be used. Vehicle information can be viewed on electronic maps via the Internet or specialized software. Display devices can be anything from mobile phone, PCS, Laptops, tablets or other electronic devices. There are three major elements of a GPS tracking system:

(a) GPS tracking device—This is mounted into the vehicle and collects the GPS location information apart from other vehicle information at regular intervals to a central server. The other vehicle information can include engine temperature, fuel amount, altitude, reverse geocoding, door open/closed, tire pressure, cut off fuel, turn off ignition, turn on headlight, turn on taillight, battery status, GSM area code/cell code decoded, number of GPS satellites in view, windows open/closed, fuel amount, emergency button status, cumulative idling, computed odometer, engine RPM, throttle position, GPRS status and a lot more.

(b) GPS tracking server: The tracking server has three responsibilities: receiving data from the GPS tracking unit, securely storing it, and serving this information on demand to the user.

(c) User interface: The UI determines how one will be able to access information, view vehicle data, and elicit important details from it.

In many such systems, if the car is reported stolen, the car engine can be switched off remotely by a car owner or a service provider through the mobile application or web application. The communication between the device mounted inside the car and the application is wireless. Many such devices also offer a geo-fencing functionality. With geo-fencing the owner defines a geographic boundary in which the car will function normal but if the car is taken out of the pre-defined geographic boundary then the car engine will switch off automatically and the user has to call the service provider to disable this geo-fencing functionality for normal functioning of the car.

However, trackers have many limitations. Since tracking services are managed and maintained by service providers so they do require yearly subscriptions, they are very costly and many times the users feel lots of problems when they have to activate or deactivate geo-fencing. They do not work in areas with weak or no signals. Many drivers have reported worst experience when they are stuck in an area with no or weak cellular signals where their car engine switches off itself and they cannot contact the service providers. Even if they contact the service provider somehow, then they first need to take their cars to an area where signals can be sent to it by the service providers. Drivers who park their cars in basements with weak signals have experienced many such issues. Lastly trackers are subjected to jammers which are low cost and easily accessed by thieves.

It has also been observed that car drivers find it extremely unpleasant to contact the service providers and pass the security questions for activating or deactivating geo-fencing.

Vehicle tracking devices and most of the other electronic auto security devices do not provide security when thieves damage these systems, cut its power supply or damage these systems.

A lockout system is armed when the driver turns the ignition key to the on position and carries out a specified action, usually flicking a hidden switch or depressing the brake pedal twice. It is activated when the vehicle drops below a certain speed or becomes stationary, and will cause all of the vehicles doors to automatically lock, to prevent against thieves stealing the vehicle when it is stopped, for example at a traffic light or pedestrian crossing.

A transponder system is a system which is always armed until a device, usually a small RFID transponder, enters the vehicle's transmitter radius. Since the device is carried by the driver, usually in their wallet or pocket, if the driver leaves the immediate vicinity of the vehicle, so will the transponder, causing the system to assume the vehicle has been hijacked and disable it. When a driver with the device in his pocket approaches the vehicle, the system acknowledges this and unlocks the car, allowing the owner to simply pull the door handle to gain entry to the vehicle.

A car alarm is an electronic device installed in a vehicle. When certain conditions required for triggering the alarm are met, they emit high-volume sound. Some of the vehicle's lights are also flashed, and (optionally) the car's owner is notified via a paging system. They may also interrupt various electronic circuits necessary for the car to start.

An immobilizer is an electronic security device fitted in an automobile that prevents the engine from running unless the correct key (or other token) is present. This prevents the car from being “hot wired” after entry has been achieved. Immobilizers have been mandatory in all new cars sold in Germany since 1 Jan. 1998 and later on in other countries.

Immobilizers are now an old technology as thieves have learnt bypassing the system. At the same time its replacement is costly and varies for different cars. If someone loses his/her device, it may cost as much as over £150 per key for a replacement/copy.

One common limitation to transponders, immobilizers and keyless car entries is that if someone misplaces it or loses it then taking a replacement copy requires a lot of time, effort and cost.

With many of the existing keyless entry systems, transponders, immobilizers and others as described above, it is extremely difficult and costly for a genuine car driver to change his key only on the basis of suspicion. If you give your physical key fobs or access of your car to someone (say to car technicians or car wash staff), they can done your keys within less than 20 seconds. In these systems, it is costly (typically over 150 pounds) to get a replacement copy for key fobs and other devices on the basis of doubt of key cloning. Even if you were to make a copy, you have to request the technicians who can potentially keep a cloned key.

There have been many situations where a driver doubts that someone might have cloned his/her keys. All the above creates a strong need for a system that allows a genuine driver to create copies easily at no cost but still difficult enough for the illegitimate persons to access such keys.

All of the above systems do not provide an anti-snatching mechanism. If a thief snatches (access by force) the key or authorized device (having transponder, immobilizer or other keyless entry device), they can easily take away the vehicle. Some tracking devices also include an ability to remotely switch off engine when it is stolen by a thief. However, they don't work when thieves deactivate the tracking device or jam communication using jammers.

### SUMMARY

According to an aspect, there is provided a method for implementing security on a vehicle, comprising integrating an auto device on the vehicle, receiving, at the auto device, input from a remote device to authenticate the remote device to the auto device, verifying, at the auto device, that the remote device is a first authenticated remote device or one of a sequence of at least one subsequently authenticated remote devices, and enabling a security related function of the vehicle upon receiving, at the auto device, instruction from the remote device if the remote device is a first authenticated remote device.

The method may further comprise disconnecting the first authenticated remote device thereby designating the next authenticated remote device in the sequence of subsequently authenticated remote devices as the first authenticated remote device to enable a security related function of the vehicle upon receiving, at the auto device, instruction from the first authenticated remote device.

The input from a remote device may comprise a password, and may further comprise a random number security code. Authentication of each subsequent remote device may require a different random number security code.

The method may further comprise generating a new random number security code at the auto device after authentication of a remote device. The method may further comprise storing the most recent generated random number security code in the auto device and deleting all previously generated random number security codes in the auto device. The method may further comprise storing the most recent generated random number security code in a remote device if the remote device generated the most recent generated random number security code. The most recent generated random number security code can be generated either by the auto device or by the remote device. However, it should be stored both in the auto device and also in the remote device. When a random number security code has been verified, only a verified password may be required to connect the authenticated remote device to the auto device. Alternatively, the system can first verify the password and then the security code. Also the system may not notify the user which one of the password and random number security code has been verified and which one has not. This increases security because a user does not know which of the password and security code has been incorrectly entered.

The method may further comprise activating at least one of an anti-theft mode, an anti-snatching mode, a drunk mode or other security related mode upon receiving an input from the first authenticated remote device. The method may further comprise automatically activating anti-theft mode when the ignition or engine is switched off. The method may further comprise, when the anti-snatching mode is activated, sending an alert message or call to a preconfigured ID or phone number. The alert message or call may be accompanied with location information and/or a thief image. The method may further comprise, when the anti-snatching mode is activated, switching off the engine after a preconfigured time from activation. The method may further comprise, when the anti-snatching mode is activated, allowing operations such that the remote device seems normally connected to the auto device. The anti-snatching mode may be activated by tapping multiple times on the touch screen of the remote device. The anti-snatching mode may be activated by tapping a particular pattern on the screen of the remote device. The tapping may be performed on a user interface or application of the remote device. The method may further comprise locking the user interface and/or application after a certain time of idleness. The anti-snatching mode may be activated by a particular audio/voice message input to a microphone enabled remote device. The anti-snatching mode may be activated by pressing one or more buttons a particular number of times within a time limit or pressing one or more areas on the remote device in a particular pattern.

The method may further comprise disconnecting and/or re-authenticating the first authenticated remote device to exit the anti-snatching mode. The method may further comprise disabling the start or running of the engine when the drunk mode is activated. The method may further comprise deactivating the drunk mode after a user passes a challenge. The method may further comprise requiring the user to pass the challenge only if the user is going to be the driver of the car. The method may further comprise taking a picture of the user that attempts to pass the challenge. The method may further comprise enabling the start or running of the engine of the vehicle when the drunk mode is deactivated.

A user may provide input to the remote device in the form of an audio message, text message, and/or image.

The method may further comprise classifying a user as a legitimate person or an illegitimate person based on a sequence of actions performed on the vehicle when engine is in the start condition. The method may further comprise the auto device receiving input from at least one of an ignition, a throttle pedal and a door opening sensor to monitor a sequence of actions performed on the vehicle. The method may further comprise classifying a user as an illegitimate person if the sequence of actions is not a sequence usually followed by a legitimate person. The method may further comprise switching off a started engine after identifying the user as an illegitimate person. The method may further comprise switching off the started engine by switching a relay connected to a crank sensor of the vehicle. The method may further comprise switching off the started engine and activating security through the auto device on the vehicle.

The security related function may comprise any function that enables or disables engine running. The non-security related function may provide door lock/unlock, lights operation, music operation, air conditioning operation and/or heater operation. The method may further comprise disconnecting all previously authenticated remote devices upon manually resetting the auto device.

Generating a random number security code may be performed by the auto device or the remote device. The password may be at least one of an administrator password or a guest password. The method may further comprise using a prank password for classifying a user as a potential thief. The method may further comprise increasing the strength of auto security by increasing the number of parameter(s), sensor(s), function(s) or switch(es) that are linked to engine start/running and that can be controlled by the auto device through their connection with output switching circuitry. The method may further comprise decreasing the level or strength of auto security by decreasing the number of such parameter(s), sensor(s), function(s) or switch(es) that are linked to engine start/running and that can be controlled by the auto device through their connection with the output switching circuitry.

The method may further comprise disconnecting a previously authenticated remote device upon an administrator changing its password.

According to a further aspect, there is provided an auto device for implementing security on a vehicle, the auto device configured to implement the method.

According to a further aspect, there is provided a remote device for implementing security on a vehicle, the remote device configured to receive input from a user to authenticate the remote device to an auto device installed on the vehicle, send the input to the auto device to authenticate the remote device to the auto device, send instruction to the auto device to enable a security related function of the vehicle if the remote device is a first authenticated remote device.

The remote device may be a first authenticated remote device if any previously authenticated remote devices have been disconnected. The remote device may be further configured to generate a new random number security code after authentication of the remote device. The remote device may be an input/output device. The remote device may be a smartphone. The remote device may be a keyboard installed in the vehicle. The keyboard may always be authenticated to the auto device. The input from the remote device may be a pin number entered on the keyboard. The keyboard may be wirelessly connected to the auto device. The keyboard may have a wired connection to the auto device. The keyboard may comprise a display.

According to a further aspect, there is provided a system for implementing security on a vehicle comprising: an auto device and a remote device according to any of claims.

Accordingly, the present disclosure has been made keeping in mind the above problems occurring in the prior art, and an object of the present disclosure is to provide an improved auto security and/or auto safety system, thus showing resilience to the techniques used by thieves to bypass most of the existing auto theft systems as described above.

There is a need for a system that allows a genuine driver to login using a username and a password. That means even if keys are lost, locked inside a car or taken by a partner with him/her then the other partner can simply login from any other mobile phone by using the correct username and password.

Furthermore, a system in which a user should be able to give guest password to other users (friends, technicians etc) whenever they need to give access to car. Furthermore, the guest password may be time based. That is it may be used only for a certain time duration or it may be used if not changed by the admin.

We can solve issues with the use of Human Computer Interaction and overcoming the need of visiting a technician for key making. In addition, we provide them a mobile app based in car security system that provides a solution to modern day thieves bypassing existing systems.

In order to accomplish the above object, the present disclosure provides a method of preventing car theft by using a hardware electronic device referred to as “Auto Device” installed inside a vehicle that can activate or deactivate security on the automobiles (that is it enables the engine to run or prevents the engine from running through output switching circuitry). The auto device accepts command from an authorized remote device. The remote device can be a handheld electronic device without a display such as a handheld remote control unit; a computer or a smartphone with an application.

The system may use 3 types of passwords to distinguish between admin, guest and a thief. If a legitimate user leaves their keys, or both their keys and their phone, inside car, another phone can be used with the correct password for opening the car door(s). Doors can be opened by using the correct password with a totally new smartphone (first time connection). However, starting car with a new smartphone (first time connection) may need more in addition to the password. That is, for first time connection the user might also be asked for random security code and a request for disconnecting the previously connected device.

A thief would not be able to start the car because they would need owner's approval (disconnection of the previous device). Plus, even if your password is hacked this doesn't give them the ability to steal your car. There is more to the security than just a password. For the first time connection, a thief would also need the random security code in addition to the password. For starting the engine he may also need to disconnect any previously authenticated remote device actively connected to the auto device.

A user gives input for activating/deactivating security or other functions, through the remote device. Inputs from the user can be in the form of (a) clicking/tapping a button on remote device; (b) using a particular voice message or pattern as an input; or (c) using an image as an input to the system. Once security is activated on an automobile then engine running is disabled through an output switching circuitry controlled by the auto device. The device then prevents the engine from running even if car starting devices like keys, transponders or immobilizers are used with it.

Whenever a genuine driver wants to start the car engine, he/she can deactivate security/auto theft (enable engine running or vehicle start) by giving an input to the auto device through the remote device. This may be by way of clicking/tapping on an anti-theft button. The input is meant for deactivating security (i.e. release engine running), after which a driver would be able to start vehicle using any of the authentic device such as keys; remote control devices or other keyless devices. Vehicle may also be started with the remote device under consideration in this patent. The auto device installed inside the automobile receives instructions only from the authenticated and authorized remote device.

The system may also provide an anti-snatching feature that enables the device to switch off the engine after a certain duration (say 3 minutes) and activates security on it i.e. prevents the engine from running. The anti-snatching feature is enabled after the auto device receives a particular instruction/input (known as an anti-snatching instruction) from the user through the remote device. Once security is enabled (engine start disabled) on an automobile through the anti-snatching feature, the car cannot be started in the normal fashion. The normal functioning of the system/automobile can be restored after re-authenticating the user. This can be achieved by any of the following:
(i) restarting the auto device and then reconnecting the remote device through the correct password and random code (the use of random code for first time use can be made compulsory or optional);
(ii) disconnecting the remote device form the auto device through any other means such as by clicking/tapping on the disconnect button on the remote device and then reconnecting the remote device to the auto device through a password and/or random code; OR
(iii) through any other means that requires authentication of the remote device to the auto device.
The anti-snatching feature might not be allowed in some regions and therefore it would not be part of the system in the regions where it is not allowed by legislation. But it can be included in the system's main features whenever and wherever it is allowed.

A remote device becomes an authorized remote device only after using the correct user name and password of the desired auto device to be connected to it. The username and passwords can be entered directly through an application running on a remote device with a display and input mechanism (such as a smartphone with a touch screen). For a remote device without a touchscreen, keypad and/or screen, passwords can be entered by interfacing the remote device with some other I/O device.

Normal industry encryption standards may be used for communication or establishing connection between the remote device and auto device. When the remote device is a smartphone then a smartphone application is used as a user interface. Unlimited smartphone applications can be downloaded enabling unlimited smartphones to be used with the auto device when correct passwords are used. To perform security related functions (engine start enable/disable related functions), a random number security code may also be required in addition to the correct username and password. Passwords can be changed using administrative privileges.

The system also provides a mechanism to distinguish between an admin (the actual owner/driver of the car), a guest driver and a thief or illegitimate driver. This is done with the use of multiple passwords i.e. admin, guest or prank password(s) respectively. The prank password(s) can also be used to joke around with friends and to fool a thief who wants to snatch an automobile from a legitimate driver by forcing him/her to give the password for automobile access.

### BRIEF DESCRIPTION OF THE DRAWINGS

The above and other objects, features and advantages of the disclosure will be more clearly understood from the following detailed description taken in conjunction with the accompanying drawings, in which:

FIG. 1 is a diagram illustrating an example of a remote device;

FIG. 2 is a diagram illustrating an example of an anti-snatching skin on a remote device with a display screen such as a smartphone;

FIG. 3 is a block diagram of the auto security and auto safety apparatus to an embodiment;

FIG. 4 is an example of a flowchart illustrating a method of authenticating and connecting the remote device to the auto device through login credentials;

FIG. 5 is an example of a flowchart illustrating a method of activating security by a legitimate user (disabling engine running);

FIG. 6 is an example of architecture for activating security (disabling engine running);

FIG. 7 is an example of architecture illustrating a method of showing resilience when a thief wants to bypass the system by damaging the auto device or jamming the wireless signals;

FIG. 8 is an example of a flowchart illustrating a method of deactivating security by a legitimate user (enabling engine running);

FIG. 9 is an example of architecture for deactivating security (enabling engine running);

FIG. 10 is an example of a flowchart illustrating a method of activating anti-snatching mode and its related features;

FIG. 11 is an example of a flowchart illustrating a method of activating drunk mode and its related features; and

FIG. 12 is an example of a flowchart illustrating a method of the present disclosure that deactivates drunk mode only after driver passes a puzzle and thus ensuring that he/she is not drunk.

### DETAILED DESCRIPTION

Reference now should be made to the drawings, in which the same reference numerals are used throughout the different drawings to designate the same or similar components.

Embodiments are described below with reference to the accompanying drawings.

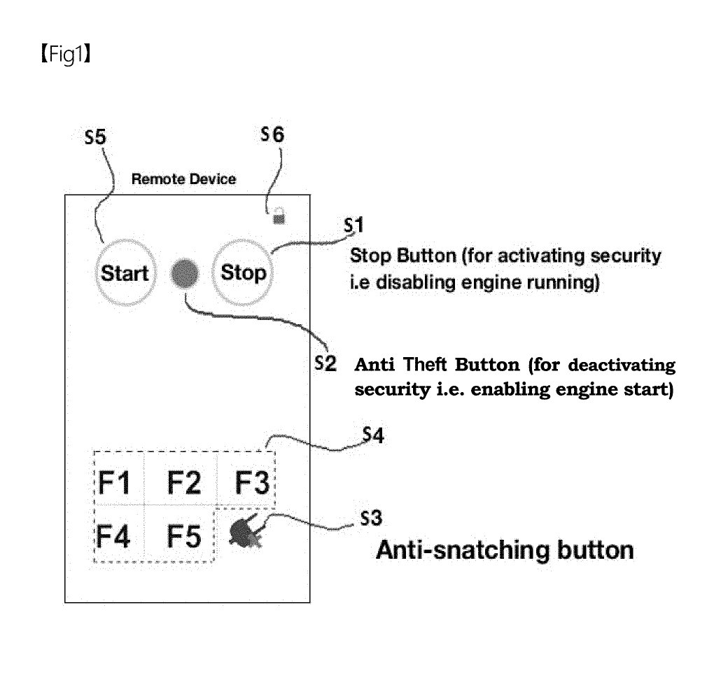

FIG. 1 is a diagram illustrating an example of a remote device. The remote device is used by the user for giving input to an auto security device. The remote device can be an electronic handheld device without a touch screen such as a remote control device; it can be an electronic device with a touch screen such as a smartphone, computer or some other electronic handheld device with a touch screen display, buttons and/or a keypad. Button S1 is used for activating security on the car (disabling engine running). In addition to activating security, button S1 can also offer an optional feature that is to switch off car engine/ignition when it is running. Security activation on the car through the auto device can also be performed automatically after a certain time of engine switch off. That means whenever a user switches off the vehicle engine through physical keys, key fobs or a remote device, then security may be activated automatically on the device after a certain time has elapsed (for example after 10 seconds or 30 seconds of engine switch off). Button S2 is used for deactivating security (enabling engine running). Button S3 is used for putting the auto device in anti-snatching mode. Unit S4 represents a number of buttons (such as F1, F2, . . . , F5) used for other functions like locking/unlocking doors, turning on lights, music, air conditioning (AC), heater etc. All functions represented by S4 in FIG. 1 are considered as part of the “other functions” or functions not linked directly to activating or deactivating security on automobile through enabling or disabling engine running. Button S5 is used to turn on the ignition and start the car engine. Buttons S5 is also optional and represents one of the “other functions”.

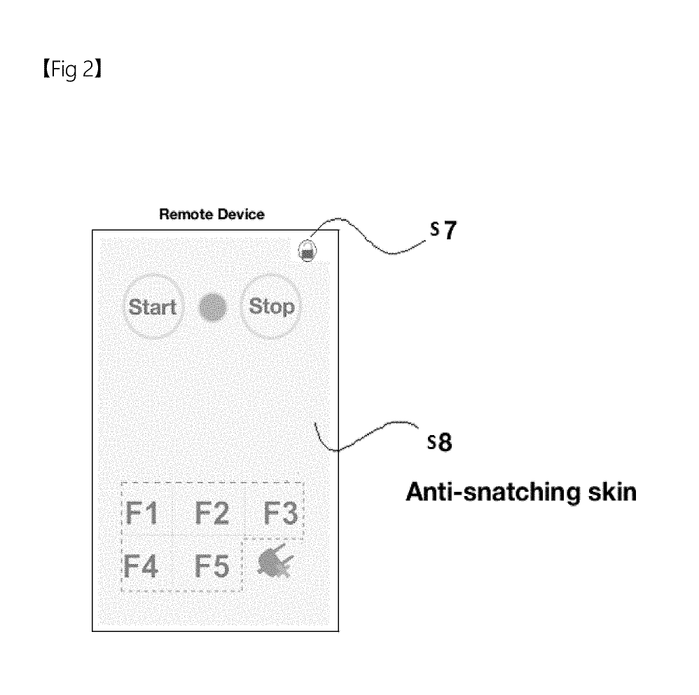

For a remote device without a touch screen, S1 to S5 will be physical buttons which need to be clicked/pressed for giving input. Button S6 will exist in a remote device with touch screen such as a smartphone and is explained in FIG. 2. For a remote device without a touch screen, button S6 will be a physical button and clicking/pressing on this button will change function of the other buttons as explained in the following section. For a remote device with touch screen such as a smartphone, S1 to S5 will be soft buttons and will be tapped to give input.

FIG. 2 is a diagram illustrating an example of an anti-snatching skin on a remote device with touch screen such as a smartphone. This locks the display and solves two serious issues, (a) It was observed that for devices with touch screen, sometimes users can accidentally tap on the soft buttons and can activate some unwanted functions. To overcome this issue after a certain time of idleness the anti-snatching skin/display S8 will come on the main screen and will deactivate the whole screen except button S7 which is used to turn off/on the anti-snatching skin and thus activate/deactivate the normal display screen; (b) the anti-snatching skin also provides a convenient and more user friendly way of giving input for activating anti-snatching mode in cases where a thief wants to snatch car by force. In such cases the user normally doesn't get a time to look at the screen and activate functions. This feature allows the user to activate anti-snatching without even looking at the screen. In such a case, the user taps on the touch screen in a certain unusual pattern but easy enough to be tapped in severe circumstances. An example would be to tap two fingers followed by a second tap of two fingers within a short time (say tapping two fingers followed by a second tap of two fingers within one second of the first tap). This makes it easy for the legitimate driver to activate anti-snatching even without looking at the device. Button S7 and anti-snatching skin S8 comes on a remote device with touch screen such as in the form of a mobile application on a smart phone. Such a method of anti-snatching input can also be used on a remote device without a touch screen. An example of a method of convenience for activating anti-snatching input in a remote device without a touch screen can be multiple clicks/taps of any button or on a specific button/area within a certain time limit (say three continuous button clicks/taps within 2 seconds) on the remote device without the touch screen. For a device without a touch screen, button S7 can be replaced with a physical button. In such a case whenever anti-snatching mode is activated on a remote device (without a touch screen) through button S7 then we can link another function to the other or all buttons. For instance, whenever anti-snatching mode is activated using button S7 then clicking a certain number of times on any button will activate anti-snatching mode. An example would be whenever anti-snatching mode is activated through S7 then clicking twice (within a certain time say one second) on any of the buttons will activate anti-snatching mode.

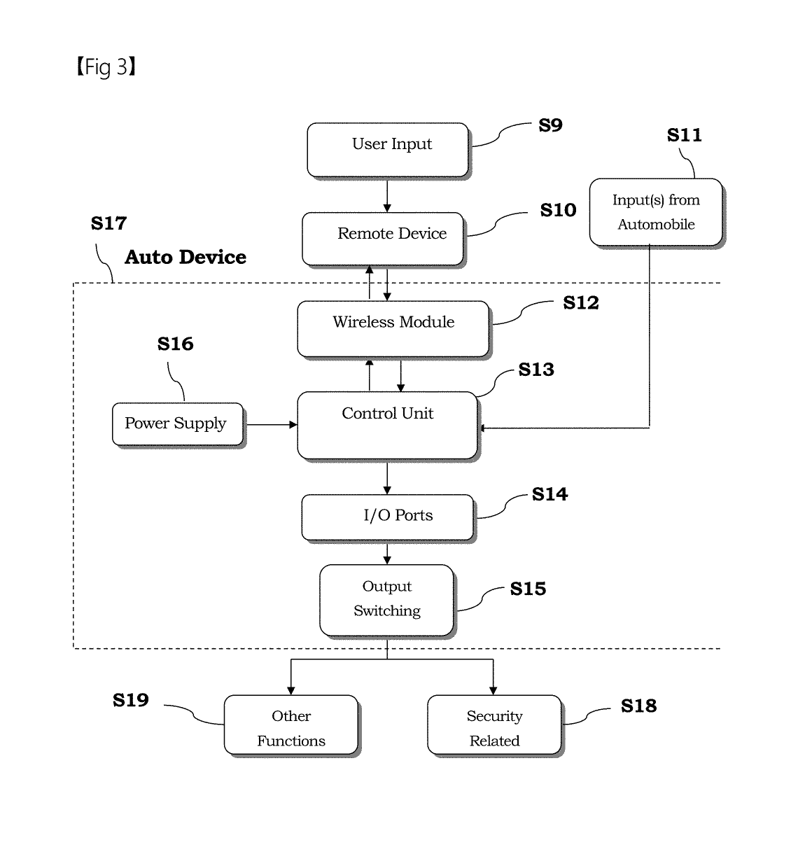

FIG. 3 is a block diagram of the auto security apparatus. The block diagram shows a user input step S9 which is a click or press for a remote device without a touch screen, a tap for a remote device with a touch screen, a voice message for a remote device with microphone, a text input for a remote device with keyboard or a combination of any of these types of inputs. User input S9 is given to the remote device S10 which processes the information/data, may encrypt it and sends it wirelessly to the control unit S13 through the wireless module S12. The wireless module S12 can be a Bluetooth, Wi-Fi, RFID, GSM, 3G, any other wireless media used alone or in a combination of any of these. An embodiment uses Bluetooth for communication between the remote device S10 and auto device S17. The control unit S13 is a microcontroller or microprocessor based control unit that decrypts the input received from the remote device S10, processes it and outputs the result to Output Switching Circuitry S15 through the I/O Ports S14. Components S12 to S16 constitute the “auto device” S17. The auto device S17 is powered through a power supply S16. In order to entertain user input S9, the Remote Device S10 may be authenticated and connected to the auto device. The auto device S17 can also receive input(s) from automobile S11. Input(s) from automobile S11 can be from various sensors or switches of automobiles and are used to update the status of various functions or parameters of a car such as status of the doors, engine, heater, AC etc. These inputs can also be used to decide whether to activate security on the car in case of some unusual activity. For instance, these inputs can be used to automatically activate security on car after a certain time of switching off car engine through any authentic device including but not limited to physical keys, remote devices or smartphone app. Another example is a situation in which for the sake of warming up the car (before driving), a user wants to turn on the heater and warm their car when it is parked in cold winter. Similarly, many users want to cool down their car when it is parked in hot summer. To turn on heater/AC, the engine can be started remotely. However, there is a potential threat to such a car in which the engine is already in the start position. Imagine if a car owner in office started car engine and hence heater when his car is parked outside of his view and is at a distance. If a thief finds the car engine in start status, he may break the vehicle window and wants to take away or maneuver the vehicle by pressing on the throttle pedal. There is some unusual behavior or pattern in this. For maneuvering a vehicle, a legitimate person would first open the vehicle door locks and then press on the throttle pedal (also called gas pedal, automobile pedal or accelerator pedal). But a pattern of pressing throttle pedal without unlocking doors through a remote device can help in identifying an unusual activity and hence an illegitimate person with a very high probability. In order to avoid this, a method can be used according to which the engine start and throttle pedal can be linked to the door locks status or some other function. The auto device will receive status inputs from engine start, throttle pedal and some other function (say door opening from the remote device). A particular function, F1 (for instance doors opening through the remote device) to another function, F2 (for instance gas pedal/accelerator or gear) required for taking away the car. Providing that the car is stationary (parked or in neutral gear) and the engine is started remotely, in order to take away the car, F1 may be performed before F2. If F1 is not performed before F2, there is a high probability that a thief has broken into a started car (maybe via breaking windows or opening doors from a non-authentic tool/device or by force). In such a situation as soon as user wants to perform F2, the car engine will switch off and security will be activated. If F1 is performed before F2, the user is classified as a legitimate user. A genuine user while planning to take off will first open the doors through the remote device (F1) and can then apply accelerator or gear etc. (F2). The auto device can also keep a check of whether the door locks were opened through the auto device, physically or by some other means. If engine is started and the throttle/gas pedal is pushed then for normal functioning the auto device may check whether the vehicle door locks were opened by a remote device or not. If the auto device finds that door locks were not opened by remote device, engine was started and throttle pedal was pressed, then the auto device will switch off the car engine and security will be activated. Certain current key fob based mechanisms do not have a security solution when the engine is already in the start position (through any other means). However, in the present system, if the engine is already in the start position it can be switched off (and security may be activated) on an attempt to take away the car if the pattern of actions performed do not match the pattern of actions performed by a legitimate user.

After security is activated, then in order to restart the engine, first security may be deactivated through an authentic remote device. While an embodiment uses a combination of engine start, throttle pedal and doors lock, other combinations and patterns of actions, functions or parameters can be used to classify (on a high probability) whether a set of actions/activity was performed by a legitimate person or an illegitimate person. This will enable the auto device to take the required actions for ensuring auto security.

Based on the User Input S9, Auto Device S17 uses Output Switching Circuitry S15 for activating or deactivating Security Related Function(s) S18 or Other Function(s) S19. Security Related Function(s) S18 are the function(s) which enable or disable normal engine running or engine start. This can be achieved by controlling one or more sensors or some other part of the car that affects the normal engine running or engine start. An example to enable or disable engine running is by switching a relay connected to the Crank Sensor of an automobile through the Output Switching Circuitry S15 of Auto Device S17. When security is enabled through the Auto Device S17, Electronic Control Unit (ECU) of a car will not receive input from the crank sensor and hence engine cannot be started. When security is disabled through the Auto Device S17, crank sensor will perform as normal and its input will be received by the ECU of the automobile. Although the embodiment enables or disables engine running/starting by switching a relay connected to the “crank sensor” or to “Fuel Pump” (an example of a Security Related Function S18) through the Output Switching Circuitry S15, however, any other sensor/parameter of the automobile having relationship with engine running/starting can be controlled and hence security on automobile can be activated or deactivated using the remote device.

Research shows that thieves would normally not attempt to hijack a car that requires them huge amount of resources and time in bypassing its security. The location of the Auto Device kit may vary with car types. However, the location of the Auto Device S17 and the sensor/parameter (connected to the output switching circuitry) that needs to be controlled for enabling/disabling engine running would normally be such that a thief would require a huge amount of time and resources to physically access and bypass the system security. This means that even if a thief is highly skilled, he would need tools and resources on the spot and a large amount of time to access and control/bypass those sensors manually. For instance, it would normally take a thief a large amount of time and resources to change/bypass the relay connected to the crank sensor. On the other hand a legitimate user would have no difficulty in activating or deactivating security as he would be able to enable or disable engine running through the remote device and the location of the installed Auto Device would not matter the legitimate driver in activating or deactivating security on automobile. This gives significant strength to the security of the automobile against auto-theft and at the same time ensuring convenience for legitimate users.

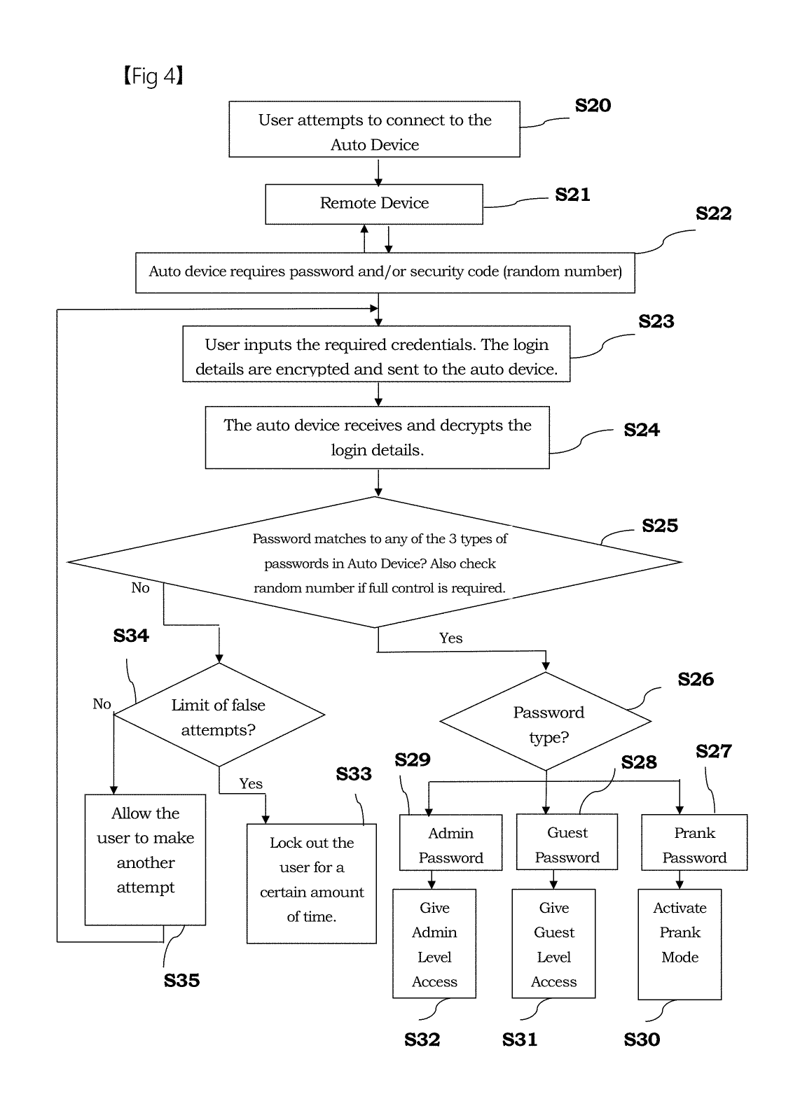

FIG. 4 is an example of a flowchart illustrating a method of authenticating and connecting the remote device (first time connection) to the auto device through login credentials. The user attempts to connect to the auto device (step S20) through the remote device S21. At step S22, Auto device requires a password and a random number for connection and requests it from the user through the remote device S21. At step S22, if the user wants to simply unlock car doors with the new smartphone and does not want to perform security related functions (functions related to enabling or disabling engine running) then only the password would be required. But if the user wants to perform all functions including security related functions on the new smartphone then in addition to the password, the user may also give a random number. Details about the random number and justification of this logic are given later. User inputs the credentials and the encrypted login details are sent to the auto device at Step S23. The password(s) and random number refers to the secret information stored in the auto device.

Each new Auto Device comes with a default factory user name, password and random number. Username and password can be changed by a user whereas random number changes automatically after a new smartphone is connected to the kit. Further details are given below.

Password(s) stored in the auto device can be changed by an administrator and are different for different auto devices. Password can also be termed as Secret code, PIN number or passcode. An embodiment of this disclosure uses a 5 digit number as a password but it can be of any size. A password can consist of (a) letters; (b) numbers; (c) special characters or a combination of letters, numbers or special characters.

The admin password may be required for changing any type of password. Further, the remote device through which password is changed should be connected to the auto device. If an administrator wants to change a guest password then he/she will change it by using the current administrator password. All other previous devices that were connected through the guest passwords will have to re-authenticate themselves because after the change in password these devices would be considered as disconnected. Only the devices that were previously authenticated and connected through the guest password would need to re-authenticate. The same procedure occurs for a prank password. If the administrator wants to change the prank password, he/she will need the existing administrator password to generate the new prank password. Anyone connected through a previous prank password would be considered disconnected now. The same procedure occurs for an administrator password. If the auto device is reset to the default setting mode, then all the previously connected devices with any type of password will be disconnected. They can reconnect through the default factory password and can also change it afterwards.

A Random Number is security code and may be required for the first time connection of a new device. Consider a new customer (user A) that purchases the auto device. He will use the default username, password and random number to get connected to the device. Once a remote device has been authenticated to the auto device using the password and random number code, only a password may be required for further connections. Setting the remote device to auto-connect mode may not require the user to feed in the password for further connections. The user will be able to change the username and password. When user A uses the default random number (security code), this number will change automatically and it will not be reusable. It will not work if another user wants to use it. A new random number (security code) will be generated as soon as a user uses it. This random number can be generated either by a smartphone or by the auto device. The new random number is stored both in the auto device and in the last authentic remote device that was authenticated and that used the previous random number. The new random number can also be sent to pre-configured and trusted remote device(s) such as a mobile phone of the car owner. After that this random number is not transmitted between the devices. A smartphone that passes the authentication using the correct password and random code will not need the random number again unless the auto device is reset OR some abnormal condition is activated like the anti-snatching mode. In such abnormal conditions the requirement of random number can be made optional.

Now assume that a user B wants to connect to the auto device for full control including other functions and security functions. User B would require password and random number security code. User B will request user A who will retrieve the random number from his remote device and give the random number security code to user B. When user B uses this random number the previous random number will be deleted and a new random number will be saved in the auto device and also in any of the authorized remote device(s), for example that of user B. The new random number security code can be shared with any other user who wants to connect for the first time.

Similarly when user C wants to connect (first time connection of his remote device) with the auto device for full control, he will request user B (or the person who has received the random number) to give him the random number that was saved last time. When user C uses this random number security code with the correct password, then user C will be able to perform all types of functions on the system. A new random number will be generated by the system that will be saved both in the remote device and in the auto device. The random number may also be sent to any authorized remote devices.

Now suppose that user C locked his remote device and his keys inside the car. At this point user C would need to unlock his car doors. However, user C remembers password of the auto device kit but he doesn't remember the random number security code. User C will borrow a remote device (such as a smartphone) from any other user (say user D). User C will then connect remote device of User D with only password (and not the random number access code) to unlock car doors. A remote device connected to the auto kit using only password can perform other functions but not the security related functions or functions that are not related to engine start. Through remote device of user D, car doors can be unlocked, user C can then access his phone from car and can also access the random number security code from his remote device (user C remote device) that can be used for giving full control to any other remote device requiring first time connection to the remote device. In the example mentioned above, a further high level of security can also be introduced wherein remote device of user D will be allowed only doors opening through the remote device of user C (already locked inside car). But in such a case remote device of user D will not be able to perform security related functions.

In the worst case, if the last connected authentic device cannot be accessed such as if the device with the last random security code is lost, then to access the last random security code, the new authentic user can open the car doors (requires only a password), and reset the auto device. Auto device can be reset by using a password/PIN code through a keypad connected to the auto device. The auto device may also be reset manually by physically accessing the auto device. However, this second option would require the user effort and time to access the reset button of the auto device. This will set the device to the factory default setting which will then require default random number security code.

A new remote device in this document means that the remote device wants first time connection to a specific auto device. It means that that particular remote device is new to that specific auto device as it wants to connect to the auto device for the first time. If a remote device is already connected to the auto device and the auto device is restored/reset then all previously connected remote devices will become new remote devices for that auto device and would need both passwords and random codes if they want to perform security functions.

The requirement of the random number security code for security related functions can be made optional. The need of random number security code provides an additional level of security which ensures security in cases where password is compromised.

The user name or device name of the auto device is not secret information and this can be seen by a remote device within the range of the auto device.

The login credentials i.e. user name (device name), password and random number can be entered directly through an application running on a remote device (such as a smartphone) with a touch screen and keypad. For a remote device without a touchscreen, keypad and/or screen, passwords can be entered by interfacing the remote device with I/O device(s). Remote devices can also come in pair with an auto device wherein the passwords and codes would come factory configured within the remote device and this way a remote device would be linked to a specific auto device to be installed inside a car.

At Step S24, The auto device receives and decrypts the login details. If the connection is desired only for controlling other functions (that is non-security related functions) then at S25 the system checks only for the correct password. But if the connection is desired for full control including both the security functions and other functions, by a remote device (for first time connection with the auto device), then at S25 the system would look for both i.e. correct password and correct random number security code. At Step S25, if the password matches, then depending on the type of matched password at Step S26, the auto device will give Admin Level Access (Step S32) for Admin password S29, Guest Level Access (Step S31) for Guest Password S28 and activation of prank mode (Step S30) for a prank password S27. In prank mode (Step S30), the auto device seems to be connected but will not function as desired by a legitimate user. It may play a particular music or sound the horn when in prank mode. An example of the use of prank password is a situation where a thief wants to access the password by force from a user, then the user will give prank password and with prank password the “other functions” i.e. functions other than those related to security will work. But security related functions for activating or deactivating security that is for enabling or disabling engine running will not work in the desired manner. For instance when a thief starts a car in prank mode (wherein a remote device S21) is connected to the auto device installed inside car through a prank password S27) the automobile will work normally for a certain duration (say 3 minutes) and will automatically switch off after a short duration (say after 3 minutes). This allows the car driver to confuse the thief and at the same time ensure his safety and security. It has been observed that with prior art, many thieves would also harm a driver or automobile owner in order to access automobile keys or information required for bypassing security. In such cases where a driver is forced to give password, a driver can give away the prank password which will activate all prank or anti-snatching related features and functionalities. The provision of a prank password (anti-snatching password) will ensure driver safety by giving him enough time to safe and secure himself/herself and at the same time the automobile will be secured as its engine would be switched off after a certain duration of prank mode activation. Prank passwords can be of many types and can also be used for friends. The prank mode can also be used to prank with friends. For a friend prank mode, certain other features can be added to the prank mode to make the scenario more like a fun for pranking with friends. An example is to add a speaker and a voice enabling feature with the automobile that would be activated for a flirt/joke with a friend by an automobile when they use prank password (meant for friends) with the auto device.

If the password entered by the user at Step S23 does not match at Step S25 with any of the three types of passwords stored in the auto device then at Step S34, the auto device checks the condition whether the user has reached a maximum number of false attempts in a row (say five consecutive false attempts). If the user has reached maximum number of false attempts; then the auto device will lock the user out for a certain amount of time (Step S33) and will not accept further attempts within that time. If the user has not reached the limit for the maximum number of false attempts, then at Step S35, the user will be allowed to make another password attempt. The user will then re-enter the password at Step S23 and the whole cycle will repeat until the password matches with any of the three types of passwords at Step S26; or the user is locked out at Step S33 after reaching the maximum number of false attempts at Step S34. The same lockout mechanism is used for false attempts on the random number.

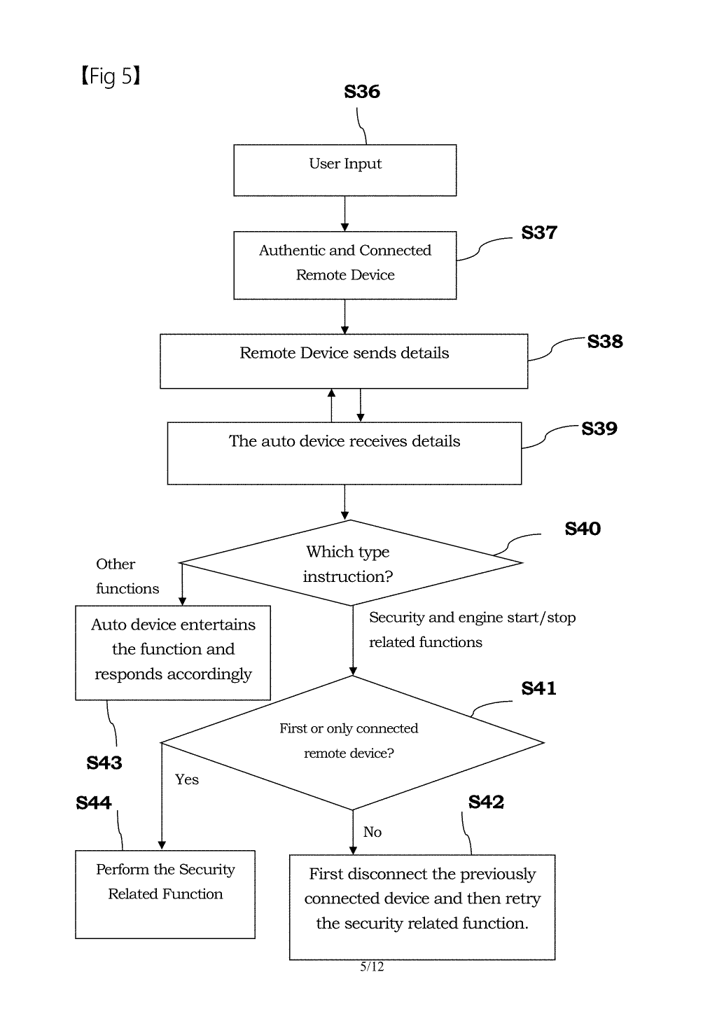

FIG. 5 is an example of a flowchart illustrating a method of activating security by a legitimate user (disabling engine running) of the present disclosure. The user input at Step S36 is given to the auto device through an Authentic and Connected Remote Device S37. The various user inputs have been discussed in detail in FIG. 1 and FIG. 2. Details of the user input are encrypted and sent by the remote device at Step S38 to the auto device which decrypts the information and processes it at Step S39. The user input at Step S36 will be one of the two main types (a) security related function aimed at enabling/disabling engine running/start (b) other functions such as S4 and S5 as discussed in FIG. 1. At step S40 the auto device decides the type of function to which the instruction is related. If it is a security related function, then at Step S41 another condition is checked by the auto device i.e. it first checks if there is any other authentic remote device currently connected to the auto device and whether the later remote device is connected before the remote device 37 that initiated this function.

For security related functions, only the first authenticated remote device in a sequence of authenticated remote devices is considered amongst the active connected devices at a particular time. This is better understood by a case scenario in which we have 3 remote devices RD1, RD2 and RD3. In a particular time duration (T1), RD1 connects first to an Auto Device, then RD2 connects and finally RD3 connects to the same Auto Device. In this time duration T1, RD1 will be the first connected device for the Auto Device and security related functions can be performed only with RD1. At another time duration (say T2), RD1 disconnects but RD2 and RD3 stay connected. So, in T2, RD2 will be the first connected device. In a third time duration T3, RD1 re-connects again but RD2 has not been disconnected during this time. So, in T3 again RD2 is the first connected device. In a fourth time duration T4, if RD2 is disconnected but R1 and R3 is connected and providing that RD3 was not disconnected in T3 and T4, then in T4 RD3 becomes the first connected device. By disconnecting the first authenticated remote device, the next authenticated remote device in the sequence of subsequently authenticated remote devices is designated as the first authenticated remote device to enable a security related function of the vehicle upon receiving instruction from the new first authenticated remote device. The use of multiple connections at a time enables to perform other important functions (non-security related). For instance, if an authentic and connected remote device is already locked inside car, then a user will be able to unlock the doors (other non-security related function) by borrowing a remote device from someone else. The user will be able to connect a second device in the presence of his first connected but locked device. A second solution to this problem is also achieved by allowing only one active connection of a remote device with the auto device at a time. And for cases of unlocking doors in case if the only connected authentic remote device is locked inside car, then any second remote device (for instance the device borrowed from someone else) will open the car doors through the first authentic remote device which in this case will be locked inside car. However, only certain limited functions like door unlocking can be performed by the second remote device through the first remote device.

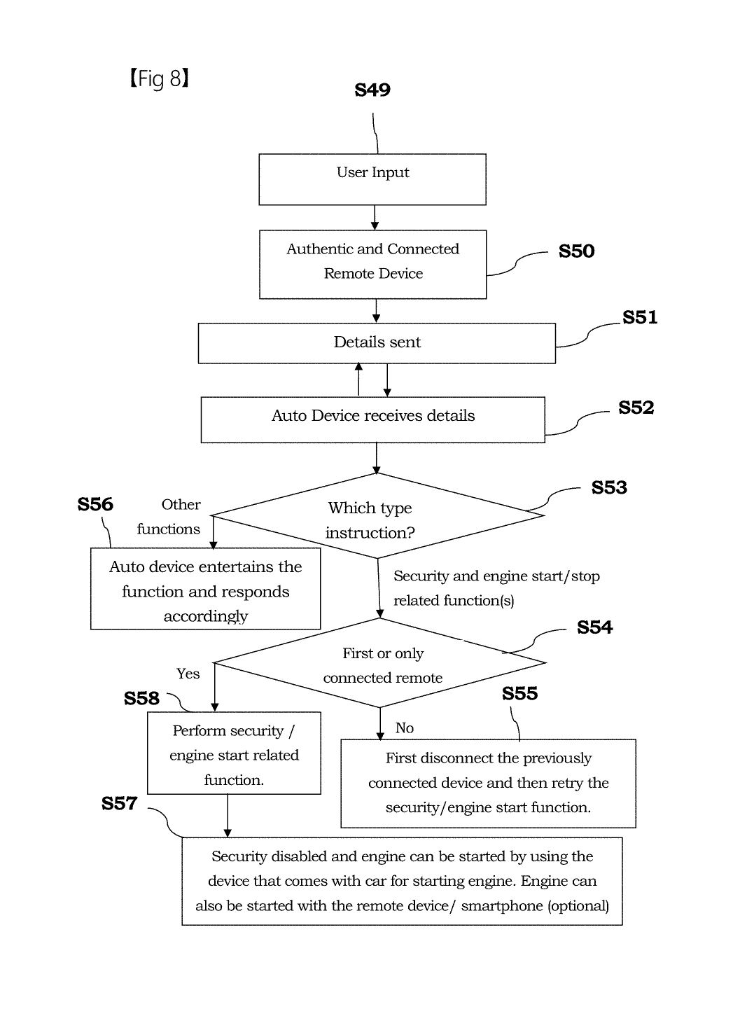

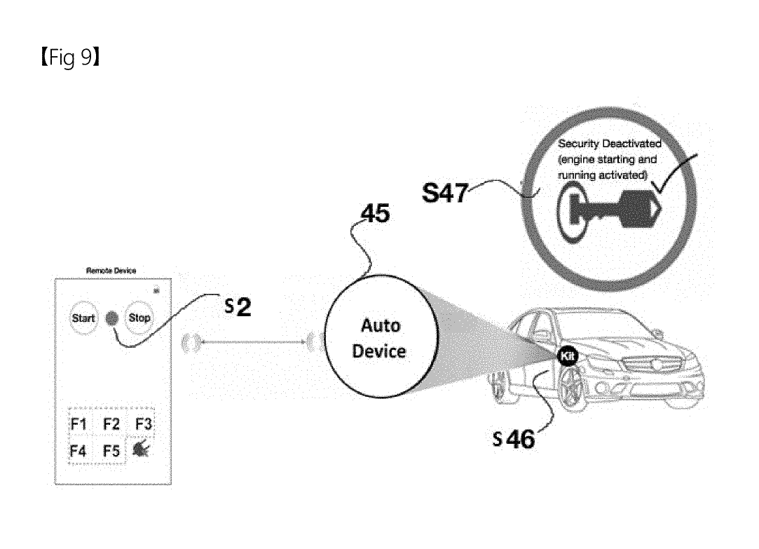

At Step S41, if the auto device finds that there is another authentic Remote Device connected before the Authentic Remote Device S37, then the user would need to first disconnect the previously connected remote device and then initiate the input at Step S36. If there is no previously connected remote device at Step S41, then the auto device will activate security which will disable engine running/starting. This means no one would be able to start/run the engine normally with the keys, remote control devices or any other equipment until the driver deactivates security as described in FIG. 8 and FIG. 9. At Step S40, if the result of verifying the type of function is “other function” then the auto device entertains the function (without checking the condition at Step S41) and responds accordingly (Step S43). At Step S41, the feature of entertaining security related functions only from the first connected remote device amongst the actively connected device provides a high level of security strength to the system. With this feature an illegitimate person would not be able to activate or deactivate security even if he/she has access to the password or if they hack the password. Thieves would need to disconnect the previous connected device and might also need the random number security code if that has been configured compulsory for new connections.

In the above example the number of previously connected authentic devices is set to one, in which case only one device can perform security related functions. However, this number can be increased to multiple numbers say to 3. That means for a 4th remote device to get connected to the system for full control (including but not limited to security related functions), it may first request disconnection of any of the previously connected 3 authorized remote devices. The new device will also need password and random number.

In addition connection of the already connected authentic devices can be through Bluetooth, 3G, IP network or other wireless media to ensure that the authentic devices are connected to the auto device even if they are far away. For instance if there is a previously connected remote device through 3G network then for a new device to connect and to perform security related function the previously connected device may first be disconnected.

On the other hand with regards to other functions (non-security related functions), the feature of the device that entertains non-security related function(s) from any authentic remote device connected to the auto device enables a user to unlock a car from any authentic remote device. These two features give a high level of security and at the same time convenience to the user. Consider a case where a user locks his smartphone and keys inside a car. His smartphone is already connected to the auto device. He takes a smartphone from his friend, download mobile app on it and authenticates the smartphone using the password. The user would not be able to activate or deactivate security on his car because his own smartphone is already connected to the auto device before his friend's mobile and security related functions can only be performed by the first authentic and connected remote device. However, the user would be able to perform non-security related function (such as unlocking car doors from his friend's smartphone). The other functions can be performed either by directly connecting to the auto device installed inside the car, or by indirectly connecting to the auto device through the first remote device such as a smartphone. In the example above, a user can connect from his friend's smartphone to his own locked smartphone inside car through an app on the friend's smartphone, OR the user can directly connect to the auto device through the friend's smartphone. But in both cases as his first smartphone is also connected and is actually connected before the smartphone of his friend, so he/she could perform only other functions (non-security related functions) with the friend's smartphone. This will enable him to unlock car doors and access his own smartphone. If the user wants to use his friend's smartphone for activating or deactivating security, he would first need to disconnect his own smartphone. This also provides a login concept to automobiles. Even if a user takes away keys with him/her, the user would be able to send login details (password) to the person who wants to access car.

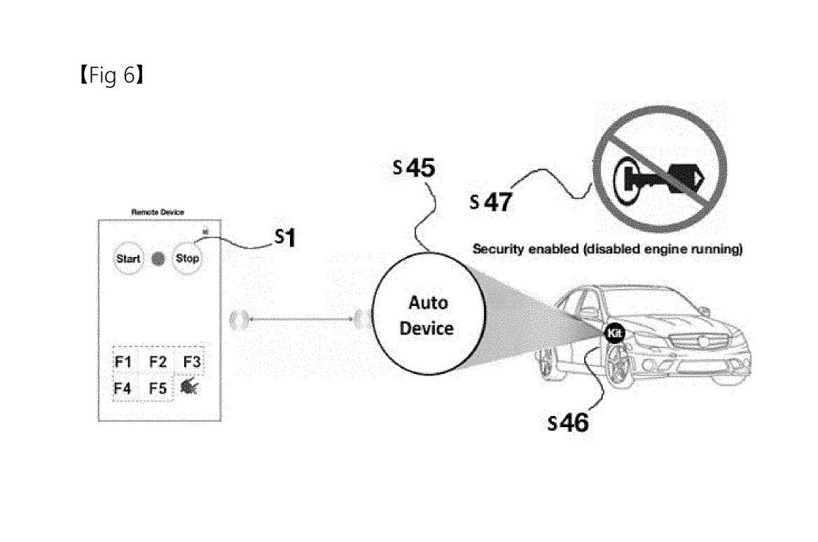

FIG. 6 is an example of architecture for activating security (disabling engine running) of the present disclosure. In FIG. 6 when the user taps on button S1, the remote device sends a message to the “Auto Device” kit S45 which is installed inside the automobile S46. In FIG. 6, automobile S46, shows a car. However, for this disclosure, automobile S46 can be any motor bike or vehicle including but not limited to car, jeep, truck, small truck, motor bike or any other automobile. The Automobile is sometimes referred to as “Auto” in this patent application. The Auto Device kit S45 activates security by disabling engine running/starting at Step S47. For instance, by using a relay with the output switching circuitry, the auto device will be able to enable or disable input from a crank sensor or some other sensor(s) which may be required for engine start. An embodiment of this disclosure controls the crank sensor switching through relay. However, instead of a crank sensor, we can control any other parameters/function responsible for enabling or disabling engine running and that can be enabled or disabled (turned on or off) through a switching circuitry controlled by the auto device S45. The strength of the security system can be increased by controlling more than one parameter/sensor/function related to engine start/running. For instance when high level of security is required and a user inputs activate security through the remote device, then this input will control many parameters/functions like controlling crank sensor, fuel injection and/or some other parameter(s). By controlling more than one parameter/sensor/function, it becomes very difficult for a thief to bypass the security and at the same time it makes the process seamless for the user.

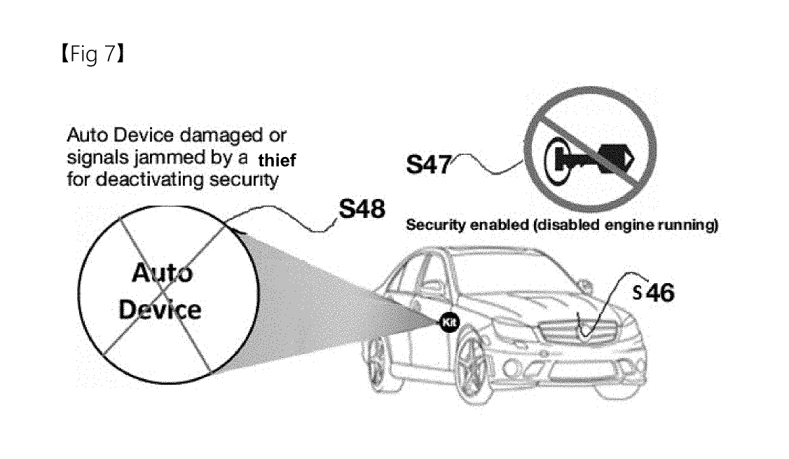

FIG. 7 is an example of architecture illustrating a method of showing resilience when a thief wants to bypass the system by damaging the auto device or jamming the wireless signals between the remote device and the auto device. With many prior art security solutions, one of the main limitations is that when thieves damage those systems or simply cut their power supply then these security solutions do not work and the security that they provide can easily be compromised. Such anti-security techniques used by thieves for bypassing prior art cannot compromise the security of the present disclosure. If security is enabled on the apparatus installed in an automobile S46, this security cannot be deactivated by cutting the power supply, jamming the signals using jammers or damaging the auto device (Step S48) of an automobile S46. In order to deactivate the security activated as shown in Step S47, the auto device should be in its normal condition and working properly otherwise the only other option is the costly and time consuming process of locating and manually accessing the components of activating security (such as bypassing the relays or accessing the specific sensors) and adjusting its connection(s) manually to bypass the system. Since the location of such components/sensors like crank sensor is very complicated; it would be extremely difficult, costly and time consuming for a thief to make an attempt to access these sensors physically. On the other hand, a genuine user would be able to control a relay connected to this sensor easily with the remote device as described in FIG. 8.

FIG. 8 is an example of a flowchart illustrating a method of deactivating security by a user (enabling engine running) of the present disclosure. For deactivating security, user input (at Step S49) is given through S2 (FIG. 1) of Authentic and Connected Remote Device S50 which encrypts the details and sends it at Step S51 to the auto device which receives the details at Step S52 and further processes it. At S53 the auto device performs the same checks on the type of function as we discussed previously for Step S40 in FIG. 5. At step S54 of FIG. 8, auto device ensures that there is no other previously authentic and connected device. Providing that there is no previously authentic and connected device, the auto device will deactivate security by enabling engine running at step S58. This will disable security and engine can now be started by using the traditional engine starting devices that comes with the car like keys, remote control devices. Engine may also be started with the remote device of this disclosure but this is an optional feature and is a type of the other functions which are not considered as directly related to activating or deactivating security (disabling or enabling engine running) on the automobile. An example of engine start of the present disclosure is achieved by S5 (in FIG. 1) of the remote device. FIG. 9 is an example of architecture for deactivating security (enabling engine running) of the present disclosure. A user clicks/taps on S2 which sends an instruction to the auto device S45 which in turn deactivates security (enable engine running) at step S47 of FIG. 9 on the automobile S46.

If the mobile battery is off, the dependency of engine start on the mobile phone can be deactivated by borrowing a phone from someone else. However, in a situation where the mobile battery is flat and a user doesn't have access to any other charged phone, the following options may be used. There is small keyboard or keypad inside the car. This keyboard or keypad is interfaced with the auto device and the user can deactivate the system's security by entering a pin. This will deactivate the car security (enable engine running). If the car engine is already started from mobile app and then the mobile battery is off. In such a case, the user can use the same keypad to switch off car engine by using a button or pattern of this keypad. In the above case, a system uses a keypad as the input device. However, this input device can be keypad, keyboard, microphone (for voice input), camera (for image input) or touch screen for pattern input. A system might use a combination of more than one of these devices for multiple inputs (authentication) to activate/deactivate security or perform other functions.

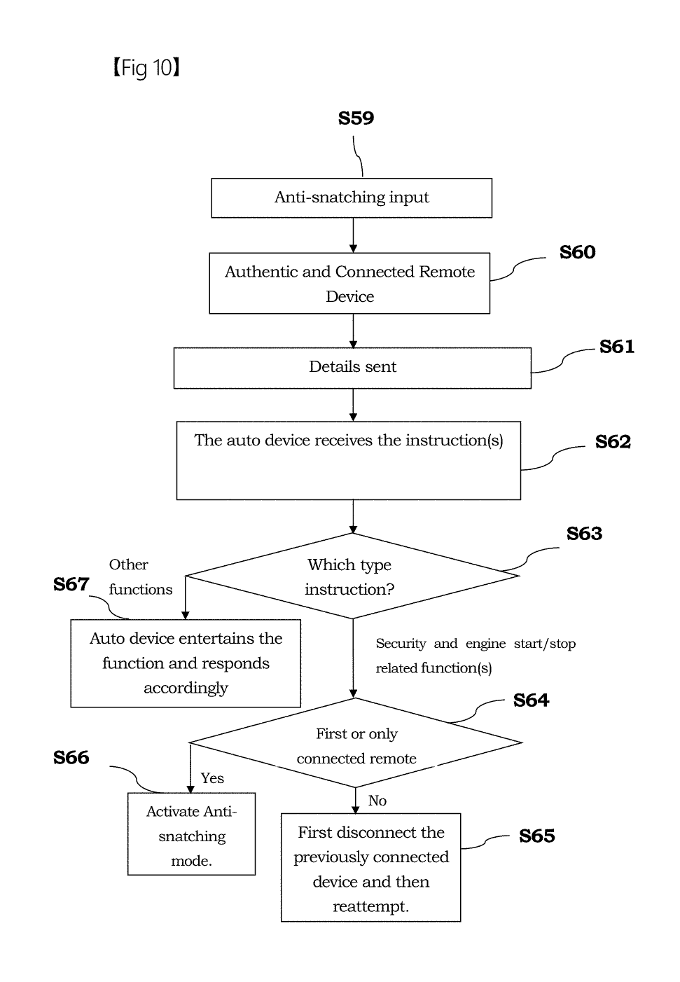

FIG. 10 is an example of a flowchart illustrating a method of activating anti-snatching mode and its related features of the present disclosure. An anti-snatching input is given by the user at Step S59 through an Authentic and Connected Remote Device S60. At Step S61, the information is sent by the remote device which is received by the auto device at Step S62. At Step S63, the auto device finds that the instruction is security related and providing that the decision at Step S64 finds no previously authentic remote device connected to the targeted auto device, the anti-snatching feature will be activated on the auto device at Step S66. The anti-snatching feature will then perform the features required for such a situation. In the anti-snatching mode, an embodiment of the present disclosure shows six main features/functions (a) it switches off a running engine after a preconfigured time (say after three minutes) of activation of the anti-snatching mode; (b) activates security i.e. disables engine running (c) auto device cannot deactivate security in the anti-snatching mode (d) the remote device may still appear to be connected to the auto device in order to confuse the thief (e) a thief would be able to perform other functions except functions related to engine starting/running or security related functions (g) an optional feature of sending a pre-configured alert message with location in the form of an email, SMS or call is sent to a preconfigured ID and/or number. The messages are sent on intervals and providing that auto device is equipped with an optional GPS device, it may also send location information of the vehicle. Depending on the type of remote device and the type of features required in an auto snatching situation, some of the above 6 features can be optional. Other features required in an anti-snatching mode can also be performed on activation of the anti-snatching mode.

To get back to the normal operation of the auto security and safety device, a user would need to re-authenticate the remote device to the auto device. The re-authentication can be performed through the correct Admin password or Guest password. To get back to the normal operation, a system also requires the random number in addition to the password. However, the requirement of the random number in such a case can be made optional.

In some minute cases of auto snatching, a legitimate driver might not get a chance to double tap two fingers on the screen, in which case the driver would be able to utter out a particular pre-configured message that will work as an audio based anti-snatching input for activating the anti-snatching mode on the auto device. An example of audio based anti-snatching message can be as simple as “Have a safe journey my mate” or any other preconfigured message meant for activating anti-snatching input. The anti-snatching input can be configured using a smartphone by a user. It can also come as a factory configured message in the device. It can also be burnt/stored in the remote device or auto device by interfacing it with some other device such as a computer or code burner.

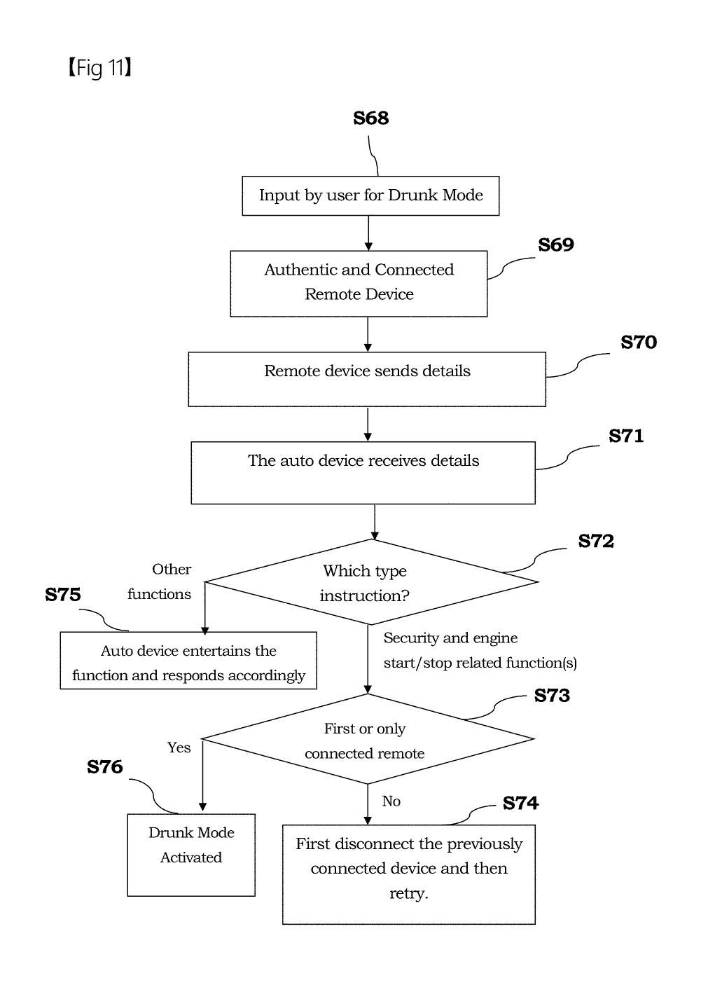

FIG. 11 is an example of a flowchart illustrating a method of activating drunk mode and its related features of the present disclosure. Drunk mode will be used by users who are worried of getting drunk and then being unable to drive. Before drinking a user will activate drunk mode by giving the input for drunk mode (Step S68) through the authentic and connected remote device S69. An embodiment of the present disclosure has a button to be tapped on a smartphone app as an input to the drunk mode. Depending on the requirement, the drunk mode can also be activated automatically after a certain time of engine switch off. This is especially good for organizations such as bus transport company to ensure that the driver is not drunk by passing the challenge phase before driving. At Step S70, the remote device sends information to the auto device which receives the information at Step S71 and processes it. The drunk mode function is a safety function and at Step S72, it will be classified as a Security Function in this present disclosure. At Step S73, providing that no previous authentic remote device is connected to the auto device, the auto device will activate drunk mode at Step S76. In the drunk mode, security is enabled that means engine running/start is disabled. Functions other than security or engine start will work as normal in the drunk mode. Automobile cannot be started when it is in drunk mode. To start an automobile or enable engine running the drunk mode may be first deactivated.

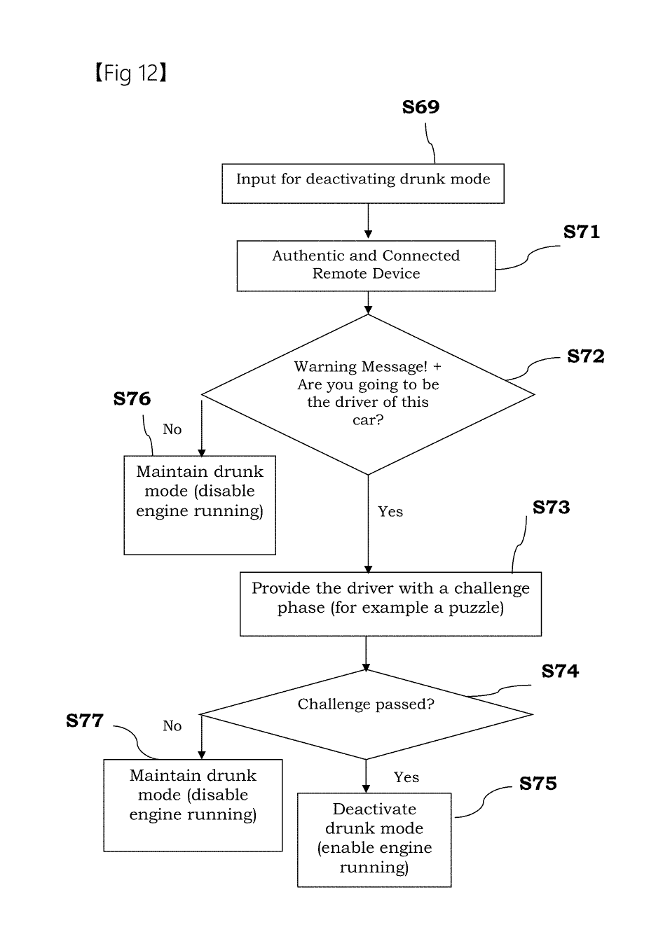

FIG. 12 is an example of a flowchart illustrating a method of the present disclosure that deactivates drunk mode only after driver passes a puzzle or challenge, thus ensuring that he/she is not drunk. To deactivate drunk mode, at Step S69, the user inputs through button S2 of FIG. 1 or through a button on the remote device S71 meant for deactivating drunk mode. At Step S72, the user may be provided with a warning message that the user who is going to solve the challenge at Step S73 may be the person who is going to drive the automobile for which deactivating drunk mode is desired. The user maybe warned that he/she should not solve the puzzle at Step S73 for someone else as only the driver of the automobile should solve this puzzle. After this message at Step S72, the user is given two options of “Yes” or “No” to confirm whether he/she is going to drive this car after drunk mode is disabled. If the user selects that he/she is going to be the driver then the auto device will ensure that the driver is conscious and not drunk to a level considered risky for the driver. This is achieved by providing the driver with a challenge phase (Step S73) such as solving a puzzle that is difficult enough to be solved by a drunk person but easy enough to be solved by a non-drunk person. The challenge can also be in the form of a breathalyzer test wherein a breathalyzer is connected or interfaced with the remote device and the alcohol content in the breath sample is estimated. If the user passes the challenge at Step S74 then drunk mode is deactivated at step S75, security is deactivated and engine running/start is enabled, otherwise drunk mode is maintained at Step S77. The level of difficulty of the challenge phase can be changed to easy, difficult, very difficult or any other level of difficulty. An optional added feature is that if the user is using a smartphone with a camera as a remote device, a photo of the user solving the puzzle may be taken. The photo is then stored on the remote device, remotely on a server or both. This photo can be later used when required to confirm that only the driver solved the puzzle.

Meanwhile, the above-described anti-theft and anti-snatching methods may be integrated into the existing keyless and electronic key security solutions. The security and safety method(s) as mentioned above can be easily programmed into the keys, authentication mechanisms and/or ECUs of automobiles. The functionalities of the auto device can also be integrated into ECUs (Electronic Control Units) of existing cars in which case there would be no need to use a separate auto device to attain the security and safety functions as mentioned above.

As described above, according to the present disclosure, the user can conveniently and rapidly activate or deactivate security on automobile through a handheld remote device such as a smartphone. This device can significantly decrease the number of auto thefts. This will reduce not only financial losses but will also result in the reduction of crimes as theft automobiles are many times used for crimes involving innocent vehicle owners in legal issues.

As discussed in the background section, in the prior art like immobilizers, transponders and others if thieves clone these, it is very difficult, costly and time consuming for the owner to get replacements. On the other hand, in our system a user will be able to change passwords within a few seconds. Further when a smartphone is used as a remote device and a mobile app as a user interface, a user would be able to download free smartphone app copies on multiple smartphones which anyone carries anyways. A user would not be required to carry anything extra and manage keys or remote devices. With all these features a more enhanced security than immobilizers and transponders is provided. When security is activated on an automobile installed with the apparatus, its security cannot be deactivated even when power supply to the device is disconnected, the auto device is damaged or its communication is jammed.

The system of the present disclosure also shows resilience and an improved security level even if the password is hacked. The feature as discussed in Step S41 of FIG. 5 does not entertain security related functions from a remote device in the presence of another connected remote device which was connected to the auto device before. This feature does not allow an illegitimate person to deactivate security even if he/she has access to the password or if they hack the password. The feature of the device that entertains non-security related function(s) from any remote device connected to the auto device enables a user to unlock car doors from any authentic remote device (such as by downloading a mobile app on smartphone of a friend and then connecting it to the auto device after authentication). This is useful in cases when the user locks his/her connected authentic smartphone and keys inside car. The user would be able to unlock car doors from any smartphone (say from friend's smartphone).

The Anti-Drunk Driving mode feature would help in reducing the number of accidents, legal issues and other related losses. Many drivers unintentionally drive when they are drunk and risks points on their driving license, human losses, financial losses, damages and accidents.

Although the embodiments have been disclosed for illustrative purposes, those skilled in the art will appreciate that various modifications, additions and substitutions are possible, without departing from the scope of the invention as defined in the accompanying claims.

Also disclosed herein:

A security system for an automobile, the system comprising: a remote device and an auto device provided in the vehicle, and comprising the steps of:

(a) authenticating the remote device to the auto device, and enabling auto device to enable or disable engine running/start based on the input from the remote device;

(b) entertaining security related functions only from the first authentic and connected remote device;

(c) requiring disconnection of the previously connected device for a situation where a second remote device needs to operate security related functions;

(d) requiring a random number security code in addition to the correct password for authorizing a remote device for security related functions;

(e) entertaining any authentic and connected remote device even in the presence of previously connected authentic device to perform non-security related functions entitled as other functions.

Optionally, the system comprises: a remote device and an auto device provided in the vehicle, and comprise of any single, all or a combination of any of the five steps i.e. Steps (a), (b), (c), (d) and (e).

Optionally, step (a) comprises the step of using Admin password or a Guest password for authenticating the remote device to the auto device, and using Prank password for classifying a user as a potential thief or a friend being pranked with.

Optionally, step (a) further comprises the step of automatically activating security on the vehicle through the auto device after a certain time of ignition/engine switch off has passed.

Optionally, step (b) is performed in such a way that a user needs to initiate an anti-theft input, anti-snatching input, drunk mode input or other security related input through an authentic and connected remote device that is connected to the auto device before any other remote device connected at that particular time.

Optionally, the step (c) can be performed by a second remote device in the presence of a previously connected device but only after disconnecting the first device to make the former device as the first connected device at that time.

Optionally, step (e) is performed by any authentic and connected remote device without considering whether another authentic remote device is connected or not.

A method of auto anti-snatching using a remote device and auto device, comprising the steps of:

(a) activating the anti-snatching input from the remote device to be sent to the auto device;

(b) sending an alert message or call on a preconfigured ID or number;

(c) switching off engine after a preconfigured time of activating anti-snatching mode, activating security by disabling engine running/start;

(d) allowing operations and activation of other functions for confusing the thief such that the remote device seems normally connected to the auto device.

Optionally, the method comprises of a combination of any, all or a combination of steps (a), (b), (c) and (d).

Optionally, in step (b), an alert message accompanied with location information and/or thief image is sent when anti-snatching mode is activated from a remote device.

A method of activating anti-snatching by tapping multiple times anywhere on the touch screen of a remote device; or in a particular pattern on the screen of a remote device. When remote device is a smartphone then such tapping may be performed on the user interface or mobile app of a smartphone.

Optionally, the method of activating anti-snatching includes locking the user interface of the application after a certain time of idleness, to avoid accidental taps and make most portion of the screen available to be used for anti-snatching input activation.

Optionally, the method of anti-snatching input on the remote device activated by a particular audio/voice message as an anti-snatching input to a mic enabled remote device.

Optionally, the method of turning the functions of all buttons to anti-snatching enabled after clicking a particular button on the remote device without a touch screen.

A method of anti-snatching input on the remote device without a touch screen or display, in which a user presses/clicks certain buttons a particular number of times within a time limit or pressing certain areas on the remote device in a particular pattern.

A method of activating drunk mode using remote device and auto device comprising the steps of:

(a) activating the drunk mode by receiving drunk mode activation input from an authentic remote device that is connected before any other connected device at that time;

(b) by disabling engine running/start in the drunk mode, and activating security on the car in drunk mode;

(c) entertaining other functions not related to engine running/start to operate in the drunk mode;

(d) by deactivating the drunk mode only after passing the challenge phase such as passing breathalyzer test or solving a puzzle difficult enough to be solved by a drunk person but still easy to be solved by a normal non-drunk person;

(e) by warning the user to solve the puzzle only if he/she is going to be the driver of the car and not to solve it for any other person;

(f) taking a picture of the user who is going to solve the puzzle.

(g) changing the level of difficulty of passing the challenge

Optionally, the method of activating drunk mode using remote device and auto device comprises any, all or a combination of steps (a), (b), (c), (d), (e), (f) and (g).

Optionally, the user input given to the remote device can be in the form of an audio message, text message, and/or image.

A method of classifying a user as a legitimate person or an illegitimate person based on the pattern or sequence of actions performed on the automobile when engine is in the start condition, and that comprises of the steps of:
(a) Identifying the user as a potential thief, if the sequence of actions are not the ones usually followed by a legitimate person, such as, pressing the throttle pedal on a started engine without opening door locks through an authentic remote device or through any other authentic device meant for unlocking door locks of the automobile
(b) Switching off a started engine and activating security on the automobile after identifying a user as probably an illegitimate person on the basis of unusual activity as set forth in step (a) of claim 16.

Optionally, a smartphone application is used for communication between the remote device and auto device installed inside the automobile for activating any function or feature herein described.

Optionally, an anti-theft and anti-snatching device for automobiles may also provide other functions such as doors lock/unlock, lights, engine start and others in addition to any, few or all of the functions/features based on the methods.

A method in which the security strength of the present disclosure may be increased or decreased, by increasing or decreasing respectively the amount of time, efforts and resources required from a person for bypassing/cracking the system; and that is achieved by the following steps:
(a) Increasing the strength of auto security is achieved by increasing the number of such parameter(s), sensor(s), function(s) or switch(es) that are linked to engine start/running and that can be controlled by the auto device through their connection with the output switching circuitry; and
(b) decreasing the level or strength of auto security is achieved by decreasing the number of such parameter(s), sensor(s), function(s) or switch(es) that are linked to engine start/running and that can be controlled by the auto device through their connection with the output switching circuitry.

We claim:

1. A method for implementing security on a vehicle, comprising:
receiving, at an auto device, input from a first remote device to authenticate the first remote device to the auto device;
verifying, at the auto device, that the first remote device is an authenticated remote device or one of a sequence of at least one subsequently authenticated remote devices; and
enabling a security related function of a vehicle associated with the auto device upon receiving, at the auto device, instruction from the first remote device if the remote device is a first authenticated remote device.

2. The method of claim 1 further comprising:
disconnecting the first remote device;
designating a second remote device as the one of the sequence of subsequently authenticated remote devices; and
enabling a security related function of the vehicle upon receiving, at the auto device, instruction from the second remote device.

3. The method of claim 1, wherein the input from a remote device is selected from a group consisting of a password and a random number security code.

4. The method of claim 1 wherein a random number security code used to authenticate the first remote device is different from a random number security code used to authenticate a subsequent remote device.

5. The method of claim 1 further comprising generating a new random number security code subsequent to each remote device authentication, wherein the new random number security code is generated by the auto device or by the authenticated remote device.

6. The method of claim 1 further comprising:
responsive to an input from the first remote device while connected, activating a function selected from a group consisting of an anti-theft mode, an anti-snatching mode, and a drunk mode.

7. The method of claim 6 further comprising:
switching off engine after a preconfigured time from activation responsive to the anti-snatching mode being activated.

8. The method of claim 6 wherein the anti-snatching mode is activated by tapping multiple times on a user interface, rendered by the first remote device, within a time limit on the touch screen of the first remote device, or by tapping the particular pattern of the user interface rendered on the screen of the first remote device within the time limit.

9. The method of claim 6 further comprising disabling the engine of the vehicle responsive to the drunk mode activation.

10. The method of claim 6 further comprising deactivating the drunk mode after a user passes a challenge.

11. The method of claim 1 further comprising classifying a user as a legitimate person or an illegitimate person based on a sequence of actions performed on the vehicle when engine is in a start condition.

12. The method of claim 11 further comprising the auto device receiving input from at least one of an ignition, a throttle pedal and a door opening sensor to monitor the sequence of actions performed on the vehicle.

13. The method of claim 11 further comprising classifying the user as the illegitimate person responsive to the sequence of actions taken by the user is different from the sequence of actions followed by the legitimate person.

14. The method of claim 11 further comprising switching off a started engine responsive to identifying the user as the illegitimate person.

15. The method of claim 1 further comprising disconnecting all previously authenticated remote devices upon resetting the auto device through an authenticated keypad of the first remote device.

16. A remote device for implementing security on a vehicle, the remote device configured to:
receive input from a user to authenticate the remote device to an auto device installed on the vehicle;
send the input to the auto device to authenticate the remote device to the auto device; and
send instruction to the auto device to enable a security related function of the vehicle responsive to the remote device being authenticated.

17. The remote device of claim 16 wherein the remote device comprises an input/output component.

18. An auto device for implementing security on a vehicle, wherein the auto device is configured to implement a method comprising:
receiving, at an auto device, input from a first remote device to authenticate the first remote device to the auto device;
verifying, at the auto device, that the first remote device is an authenticated remote device or one of a sequence of at least one subsequently authenticated remote devices; and
enabling a security related function of a vehicle associated with the auto device upon receiving, at the auto device, instruction from the first remote device if the remote device is a first authenticated remote device.

19. The auto device of claim 18, wherein the method further comprises:
disconnecting the first remote device;
designating a second remote device as the one of the sequence of subsequently authenticated remote devices; and
enabling a security related function of the vehicle upon receiving, at the auto device, instruction from the second remote device.

20. The auto device of claim 18, wherein the input from a remote device is selected from a group consisting of a password and a random number security code.
